(19) United States
(12) Patent Application Publication
(10) Pub. No.: US 2026/0145519 A1
(43) Pub. Date: May 28, 2026

(54) SOFTWARE UPDATE SYSTEM, SOFTWARE UPDATE DEVICE, SOFTWARE UPDATE METHOD, AND STORAGE MEDIUM

(71) Applicant: HONDA MOTOR CO., LTD., TOKYO (JP)

(72) Inventors: Yasumasa KAITANI, TOKYO (JP); Yujiro KOMIYAMA, TOKYO (JP); Yutaro YASUDA, TOKYO (JP)

(21) Appl. No.: 19/399,989

(22) Filed: Nov. 25, 2025

(30) Foreign Application Priority Data
Nov. 27, 2024 (JP) 2024-205903

(51) Int. Cl. B60K 35/22; B60K 35/10; B60K 35/29; B60K 35/81; G06F 8/65

(52) U.S. Cl. CPC B60K 35/22; B60K 35/10; B60K 35/29; B60K 35/81; G06F 8/65

(57) ABSTRACT

A software update system includes a language setting unit configured to set a display language of information to be displayed on a display unit, an information acquisition unit configured to acquire campaign information, which is information concerning a software update process for an ECU, from a server device via a network, a display control unit configured to cause the display unit to display the campaign information, and a discarding processing unit configured to discard, in a case where the display language is changed by the language setting unit, campaign information acquired before the display language is changed.

### CROSS-REFERENCE TO RELATED APPLICATIONS

This application is based upon and claims the benefit of priority from Japanese Patent Application No. 2024-205903 filed on Nov. 27, 2024, the contents of which are incorporated herein by reference.

### BACKGROUND OF THE INVENTION

### Field of the Invention

The present disclosure relates to a software update system, a software update device, a software update method, and a storage medium.

### Description of the Related Art

JP 2021-009658 A discloses a program rewriting system (software update system) for vehicles. The program rewriting system for vehicles is a system capable of rewriting, over the air (OTA), application programs installed in electronic control units.

### SUMMARY OF THE INVENTION

A better software update system, a better software update device, a better software update method, and a computer-readable non-transitory storage medium storing a program that causes a computer to execute the better software update method are desired.

The present disclosure aims to solve the aforementioned problems.

A first aspect of the present disclosure is a software update system comprising a vehicle and a server device configured to communicate with the vehicle via a network, the software update system comprising: a language setting unit configured to set a display language of information to be displayed on a display unit, based on an operation input performed by a user; a campaign information acquisition unit configured to acquire campaign information, which is information concerning a software update process for an electronic control unit provided in the vehicle, from the server device via the network; a display control unit configured to cause the display unit to display the campaign information acquired by the campaign information acquisition unit; and a discarding processing unit configured to discard, in a case where the display language is changed by the language setting unit, the campaign information acquired before the display language is changed.

A second aspect of the present disclosure is a software update system comprising a vehicle and a server device configured to communicate with the vehicle via a network, the software update system comprising: a language setting unit configured to set a display language of information to be displayed on a display unit, based on an operation input performed by a user; a campaign information acquisition unit configured to acquire campaign information, which is information concerning a software update process for an electronic control unit provided in the vehicle, from the server device via the network; and a display control unit configured to cause the display unit to display the campaign information acquired by the campaign information acquisition unit, wherein the campaign information acquisition unit acquires language setting information indicating the display language set by the language setting unit and acquires, from the server device via the network, the campaign information corresponding to the display language indicated by the language setting information.

A third aspect of the present disclosure is a software update system comprising a vehicle and a server device configured to communicate with the vehicle via a network, the software update system comprising: a language setting unit configured to set a display language of information to be displayed on a display unit, based on an operation input by a user; a language setting information transmission unit configured to transmit language setting information indicating the display language set by the language setting unit to the server device in a case where a starting switch of the vehicle is switched from OFF to ON or in a case where the display language is changed by the language setting unit; a campaign information acquisition unit configured to acquire campaign information, which is information concerning a software update process for an electronic control unit provided in the vehicle, from the server device via the network; and a display control unit configured to cause the display unit to display the campaign information acquired by the campaign information acquisition unit.

A fourth aspect of the present disclosure is a software update device in the software update system according to the first aspect, the software update device comprising the language setting unit, the campaign information acquisition unit, the display control unit, and the discarding processing unit.

A fifth aspect of the present disclosure is a software update device in the software update system according to the second aspect, the software update device comprising the language setting unit, the campaign information acquisition unit, and the display control unit.

A sixth aspect of the present disclosure is a software update device in the software update system according to the third aspect, the software update device comprising the language setting unit, the language setting information transmission unit, the campaign information acquisition unit, and the display control unit.

A seventh aspect of the present disclosure is a software update method for performing a software update process for an electronic control unit provided in a vehicle, the software update method comprising: a language setting step of setting a display language of information to be displayed on a display unit, based on an operation input performed by a user; a campaign information acquisition step of acquiring campaign information, which is information concerning the software update processing, from a server device via a network; a display control step of causing the display unit to display the campaign information acquired in the campaign information acquisition step; and a discarding processing step of discarding, in a case where the display language is changed in the language setting step, the campaign information acquired before the display language is changed.

An eighth aspect of the present disclosure is a software update method for performing a software update process for an electronic control unit provided in a vehicle, the software update method comprising: a language setting step of setting a display language of information to be displayed on a display unit, based on an operation input performed by a user; a campaign information acquisition step of acquiring campaign information, which is information concerning the software update process, from a server device via a network; and a display control step of causing the display unit to display the campaign information acquired in the campaign information acquisition step, wherein the campaign information acquisition step acquires language setting information indicating the display language set in the language setting step and acquires, from the server device via the network, the campaign information corresponding to the display language indicated by the language setting information.

A ninth aspect of the present disclosure is a software update method for performing software update processing on an electronic control unit provided in a vehicle, the software update method comprising: a language setting step of setting a display language of information to be displayed on a display unit based on an operation input by a user; a language setting information transmission step of transmitting language setting information indicating the display language set by the language setting step to a server device via a network in a case where a starting switch of the vehicle is switched from off to on or when the display language is changed in the language setting step; a campaign information acquisition step of acquiring campaign information, which is information concerning the software update process, from the server device via the network; and a display control step of causing the display unit to display the campaign information acquired in the campaign information acquisition step.

A tenth aspect of the present disclosure is a computer-readable, non-transitory storage medium having a program stored therein, wherein the program causes a computer to execute a software update method according to the seventh aspect, the eighth aspect, or the ninth aspect.

According to the present disclosure, a better software update system, a better software update device, a better software update method, and a computer-readable non-transitory storage medium storing a program that causes a computer to execute the better software update method can be provided.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic diagram illustrating a software update system according to an embodiment;

FIG. 2 is a flow diagram of a software update process according to one embodiment;

FIG. 3 is a flow chart showing a software update process performed by a software update device according to one embodiment;

FIG. 4 is a flow chart showing a campaign application process performed by a server device according to one embodiment;

FIG. 5 is a flow chart showing a campaign information management process performed by the software update device according to one embodiment; and

FIGS. 6A and 6B are diagrams for explaining the operation of the software update device.

### DETAILED DESCRIPTION OF THE INVENTION

Conventionally, software update for a vehicle-mounted electronic control unit (ECU) was performed at a dealer or the like. Recently, vehicles capable of updating ECU software over the air (OTA) using wireless communication have been commercially available, and such vehicles can update ECU software without being brought to a dealer or the like.

In a software update process via OTA, before update data used for software update is downloaded, campaign information, which is information about the software update process, is displayed for a user of a vehicle on a display unit of an in-vehicle infotainment (IVI) system or the like. The campaign information includes information about the name and version of the software on which the update process is performed, information requesting the user's permission for downloading the update data, and the like.

The campaign information is transmitted from a server device to the vehicle. While the campaign information corresponding to each language is registered in the server device, the campaign information corresponding to one language is transmitted from the server device to the vehicle to reduce the amount of communication between the server device and the vehicle. In the IVI, a display language for the information to be displayed on the display unit is set, and the server device transmits campaign information corresponding to the set display language to the vehicle. For example, for a vehicle whose display language on the display unit is set to English, the server device transmits English campaign information.

The campaign information is stored in a storage unit of a software update device, and the campaign information stored in the storage unit is repeatedly displayed on the display unit until the user's permission or rejection of the software download is given. For example, if the English campaign information is sent from the server device to the vehicle, the English campaign information is stored in the storage unit. Therefore, even if the display language setting on the display unit is subsequently changed to Spanish, there is a problem that the campaign information is repeatedly displayed on the display unit in English.

According to the present disclosure, it is possible to prevent the campaign information from being continuously displayed in the same display language when the display language on the display unit is changed.

### Embodiment

### [Configuration of Software Update System]

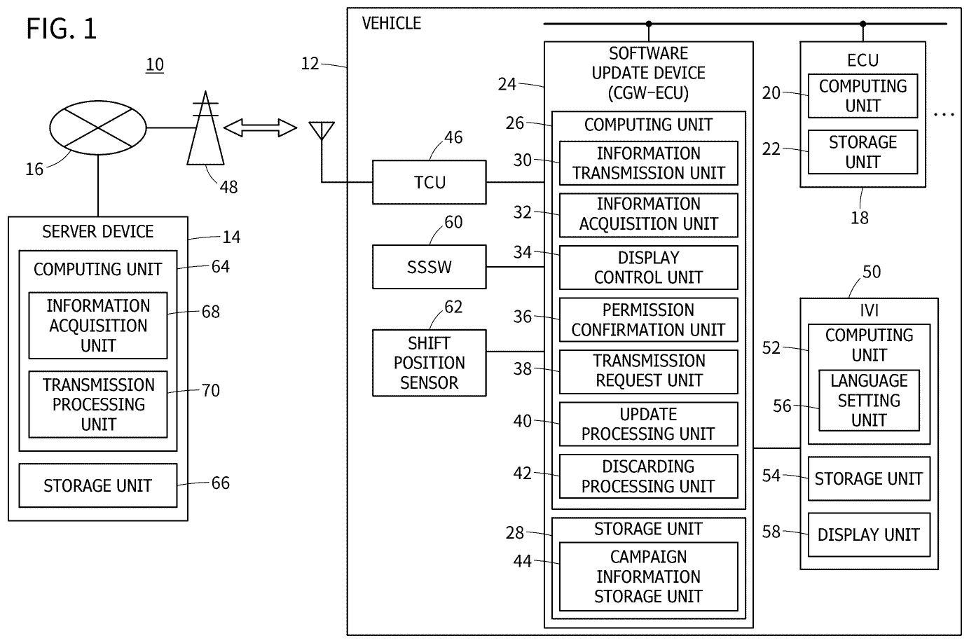

FIG. 1 is a schematic diagram illustrating a software update system 10 according to an embodiment. The software update system 10 includes a vehicle 12 and a server device 14. The server device 14 is capable of communicating with the vehicle 12 via a network 16.

The vehicle 12 is equipped with a plurality of ECUs 18. Each ECU 18 performs control to implement a traveling function and other functions of the vehicle 12. Each ECU 18 has a computing unit 20 and a storage unit 22. The computing unit 20 is a processor such as a CPU (Central Processing Unit), a GPU (Graphics Processing Unit), or the like. At least part of the computing unit 20 may be realized by an integrated circuit such as an ASIC (Application Specific Integrated Circuit), an FPGA (Field-Programmable Gate Array), or the like. At least part of the computing unit 20 may be realized by an electronic circuit including discrete devices.

The storage unit 22 is a computer-readable, non-transitory tangible storage medium. The storage unit 22 is composed of a volatile memory (not shown) and a nonvolatile memory (not shown). The volatile memory is, for example, RAM (Random Access Memory) or the like. The nonvolatile memory is, for example, ROM (Read Only Memory), flash memory, or the like. Data or the like is stored, for example, in the volatile memory. Programs, tables, maps, and the like are stored, for example, in the non-volatile memory. At least part of the storage unit 22 may be provided in the above-mentioned processor, integrated circuit, or the like. At least part of the storage unit 22 may be mounted in a device connected to the vehicle 12 via the network 16.

The vehicle 12 is equipped with a software update device 24. The software update device 24 may be constituted by, for example, a CGW-ECU (Central GateWay-Electronic Control Unit). The software update device 24 has a computing unit 26 and a storage unit 28. The computing unit 26 is, for example, a processor such as a CPU or a GPU. The computing unit 26 includes an information transmission unit 30, an information acquisition unit 32, a display control unit 34, a permission confirmation unit 36, a transmission request unit 38, an update processing unit 40, and a discarding processing unit 42. The information transmission unit 30, the information acquisition unit 32, the display control unit 34, the permission confirmation unit 36, the transmission request unit 38, the update processing unit 40, and the discarding processing unit 42 are realized by the computing unit 26 executing programs stored in the storage unit 28. At least part of the information transmission unit 30, the information acquisition unit 32, the display control unit 34, the permission confirmation unit 36, the transmission request unit 38, the update processing unit 40, and the discarding processing unit 42 may be realized by an integrated circuit such as an ASIC or an FPGA. At least part of the information transmission unit 30, the information acquisition unit 32, the display control unit 34, the permission confirmation unit 36, the transmission request unit 38, the update processing unit 40, and the discarding processing unit 42 may be realized by an electronic circuit including discrete devices.

The storage unit 28 is a computer-readable, non-transitory tangible storage medium. The storage unit 28 is composed of a volatile memory (not shown) and a nonvolatile memory (not shown). The volatile memory is, for example, RAM or the like. The non-volatile memory is, for example, ROM, flash memory, or the like. Data or the like is stored, for example, in the volatile memory. Programs, tables, maps, and the like are stored, for example, in the non-volatile memory. At least part of the storage unit 28 may be provided in the above-mentioned processor, integrated circuit, or the like. At least part of the storage unit 28 may be mounted in a device connected to the vehicle 12 via the network 16. The storage unit 28 has a campaign information storage unit 44.

The software update device 24 performs the software update process for the ECU 18. The software update process includes software download, software installation, and software activation.

Software download means acquiring update data transmitted from the server device 14 via the network 16 and storing the data in the storage unit 28 of the software update device 24. The update data is data including a program or the like of the updated software. The update data may include an installer or the like.

Software installation means to load the update data of the storage unit 28 into the ROM of the ECU 18. The software installation may be performed by an installer. Software installation may be performed by copying update data to the ROM.

Software activation means the process of authenticating the license of installed software. During the activation of software, executable files, etc. used by the prior-to-updating software may be rewritten. Upon completion of the software activation, the execution of the software is allowed in the ECU 18. Activation may be performed by the software update device 24 or each ECU 18.

The information transmission unit 30 transmits various kinds of information to the server device 14. The information acquisition unit 32 acquires various kinds of information transmitted from the server device 14. The display control unit 34 controls an IVI 50, which is described later, to display campaign information or the like, which is described later, on the display unit 58 of the IVI 50. The permission confirmation unit 36 performs a confirmation process to confirm with the user whether to execute the software update process such as software download and software activation. The transmission request unit 38 transmits an update data request to the server device 14. The update data request is a signal for requesting the server device 14 to transmit update data to the software update device 24. The update processing unit 40 performs an update process of software download, software installation, and software activation. The discarding processing unit 42 performs a discarding process for discarding the acquired campaign information stored in the campaign information storage unit 44.

The software update device 24 and the ECU 18 are connected by a CAN (Controller Area Network) (registered trademark in Japan) and can communicate with each other. A communication line connecting the software update device 24 and the ECU 18 is not limited to the CAN and may be an Ethernet (registered trademark in Japan), or both the CAN and the Ethernet may be used. Furthermore, as the communication line, a communication line according to other standards than CAN and Ethernet may be used.

The software update device 24 can communicate, via a Telematics Control Unit (TCU) 46, with a base station 48 connected to the network 16 through cellular communication. The network 16 is, for example, the Internet.

The IVI 50 is connected to the software update device 24. The IVI 50 has a computing unit 52 and a storage unit 54. The computing unit 52 is, for example, a processor such as a CPU or a GPU. The computing unit 52 has a language setting unit 56. The language setting unit 56 is realized by the computing unit 52 executing programs stored in the storage unit 54.

The storage unit 54 is a computer-readable, non-transitory tangible storage medium. The storage unit 54 is composed of a volatile memory (not shown) and a nonvolatile memory (not shown). The volatile memory is, for example, RAM or the like. The non-volatile memory is, for example, ROM, flash memory, or the like. Data or the like is stored, for example, in the volatile memory. Programs, tables, maps, and the like are stored, for example, in the non-volatile memory. At least part of the storage unit 54 may be provided in the above-mentioned processor, integrated circuit, or the like. At least part of the storage unit 54 may be mounted in a device connected to the vehicle 12 via the network 16.

The IVI 50 provides information such as display of road traffic information and route guidance and also provides entertainment through audio, DVD, TV tuner, and so on.

The IVI 50 has a display unit 58. The display unit 58 is installed on a dashboard or the like of the vehicle 12. The display unit 58 is a touch panel display. The display unit 58 provides the user with information via images, characters, and so on and accepts operation input performed by the user. The screen of the display unit 58 is not particularly limited and may be a liquid crystal, organic electroluminescence (organic EL), or the like. The touch panel of the display unit 58 is not particularly limited and may be a resistive film type, a capacitance type, or the like. Instead of the display unit 58 that is a touch panel display, a combination of a display device such as a head-up display and a pointing device such as a motion capture device may be used.

The language setting unit 56 sets, based on the operation input performed by the user, the display language of the information to be displayed on the display unit 58.

The vehicle 12 is equipped with a start-stop switch (SSSW) 60. The power modes of the vehicle 12 is switched by the user operating the SSSW 60. The SSSW 60 corresponds to a starting switch of the present invention. When the vehicle 12 is an engine vehicle, the power modes include an OFF mode, an ACC mode, an ON mode, and a START mode. When the vehicle 12 is a hybrid vehicle or an electric vehicle, the power modes include an OFF mode, an ACC mode, and a READY mode.

The OFF mode is a state in which the power supply of the vehicle 12 is OFF. In the OFF mode, most of the equipment of the vehicle 12 cannot be used. Even in the OFF mode, a keyless entry system and the like can be used. The state of the SSSW 60 in the OFF mode may be referred to as IG-OFF or ACC-OFF. In the ACC mode, devices such as an audio device can be used. The state of the SSSW 60 in the ACC mode may be referred to as IG-OFF or ACC-ON. In the ON mode, all the equipment of the vehicle 12 can be used. The state of the SSSW 60 in the ON mode may be referred to as IG-ON. The start mode is a state in which the engine starts, and the vehicle 12 is allowed to travel after the engine starts. The READY mode is a state in which the vehicle 12 can travel by means of the drive motor. The state of the SSSW 60 in the READY mode may be referred to as READY.

The state of the SSSW 60 being IG-OFF corresponds to the state in which the starting switch of the present invention is OFF. The state of the SSSW 60 being IG-ON (or READY) corresponds to the state in which the starting switch of the present invention is ON.

The vehicle 12 is equipped with a shift position sensor 62. The shift position sensor 62 detects the shift position selected by the user's operation.

The server device 14 has a computing unit 64 and a storage unit 66. The computing unit 64 is, for example, a processor such as a CPU or a GPU. The computing unit 64 has an information acquisition unit 68 and a transmission processing unit 70. The information acquisition unit 68 and the transmission processing unit 70 are realized by the computing unit 64 executing programs stored in the storage unit 66. At least part of the information acquisition unit 68 and the transmission processing unit 70 may be realized by an integrated circuit such as an ASIC or an FPGA. At least part of the information acquisition unit 68 and the transmission processing unit 70 may be realized by an electronic circuit including discrete devices.

The storage unit 66 is a computer-readable, non-transitory tangible storage medium. The storage unit 66 is composed of a volatile memory (not shown) and a nonvolatile memory (not shown). The volatile memory is, for example, RAM or the like. The non-volatile memory is, for example, ROM, flash memory, or the like. Data or the like is stored, for example, in the volatile memory. Programs, tables, maps, and the like are stored, for example, in the non-volatile memory. At least part of the storage unit 66 may be provided in the above-mentioned processor, integrated circuit, or the like. At least part of the storage unit 66 may be mounted in a device connected to the server device 14 via the network 16.

A plurality of vehicles 12 are registered in the server device 14, and the update status of the software of the ECU 18 of each vehicle 12 is managed. The server device 14 provides each vehicle 12 with the update data for updating the software of the ECU 18 of each vehicle 12.

### [Flow of Software Update Process]

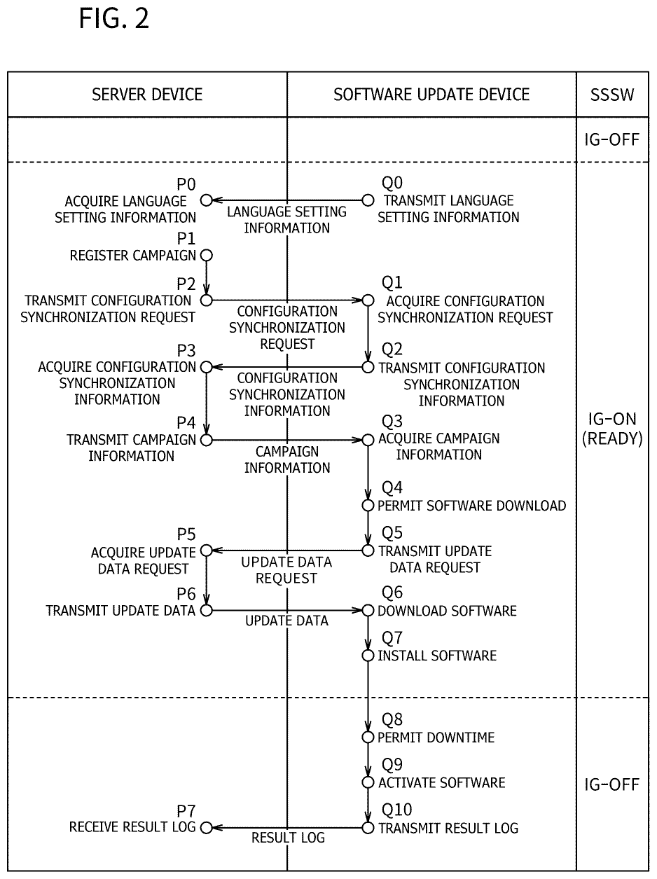

FIG. 2 is a flow diagram of a software update process according to one embodiment.

Each time the state of the SSSW 60 is switched from IG-OFF to IG-ON (or READY), the information transmission unit 30 of the software update device 24 reads out the current language setting information from the language setting unit 56 of the IVI 50. The information transmission unit 30 transmits the read-out language setting information to the server device 14 (Q0). The information transmission unit 30 corresponds to a language setting information transmission unit of the present invention. The language setting information is information indicating the display language of the display unit 58 that is set by the language setting unit 56 of the IVI 50. Switching the state of the SSSW 60 from IG-OFF to IG-ON (or READY) corresponds to switching the starting switch of the vehicle of the present invention from OFF to ON.

The information acquisition unit 68 of the server device 14 acquires the language setting information (P0). The server device 14 manages the language setting information of the display unit 58 in each vehicle 12. The information acquisition unit 68 corresponds to a language setting information acquisition unit of the present invention.

When the campaign is registered in the server device 14 (P1), the transmission processing unit 70 transmits a configuration synchronization request to the software update device 24 of the vehicle 12 (P2). The campaign, together with the update data for updating the software of the ECU 18, is registered in the server device 14 by a software developer of the ECU 18, a manufacturer of the vehicle 12, and so on.

When the information acquisition unit 32 of the software update device 24 acquires the configuration synchronization request (Q1), the information transmission unit 30 transmits the configuration synchronization information to the server device 14 (Q2). The configuration synchronization information includes information on a unique identifier assigned to each ECU 18 of the vehicle 12, information on a version of the software of each ECU 18, and the like.

When the information acquisition unit 68 of the server device 14 acquires the configuration synchronization information (P3), the transmission processing unit 70 transmits to the software update device 24 the campaign information concerning the software update process for each ECU 18 (P4). The campaign information corresponding to the display language of the display unit 58 of the IVI 50 is transmitted based on the language setting information acquired in advance.

The information acquisition unit 32 of the software update device 24 acquires the campaign information (Q3) and stores the campaign information in the campaign information storage unit 44. The information acquisition unit 32 corresponds to a campaign information acquisition unit of the present invention. The display control unit 34 causes the display unit 58 of the IVI 50 to display the campaign information. The confirmation process for confirming with the user whether to permit software download is performed by the permission confirmation unit 36. In this confirmation process, when the user permits the software download (Q4), the transmission request unit 38 transmits an update data request to the server device 14 (Q5).

When the information acquisition unit 68 of the server device 14 acquires the update data request (P5), the transmission processing unit 70 transmits the update data to the software update device 24 (P6).

The update processing unit 40 of the software update device 24 acquires the update data and stores the update data in the storage unit 28, thereby downloading the software (Q6). Then, the update processing unit 40 loads the update data of the storage unit 28 into the ROM of the ECU 18 and installs the software (Q7).

When the state of the SSSW 60 is switched from IG-ON (or READY) to IG-OFF and the shift position detected by the shift position sensor 62 is “P”, the permission confirmation unit 36 of the software update device 24 performs a confirmation process for confirming with the user whether to permit downtime. In this confirmation process, if the user permits downtime (Q8), the update processing unit 40 of the software update device 24 activates the software of the ECU 18 (Q9). The downtime indicates a time period during which the power mode of the vehicle 12 cannot be set to the START mode or the READY mode and the vehicle 12 cannot start traveling while the software activation is performed.

When the software activation of the ECU 18 is completed, the information transmission unit 30 transmits a result log to the server device 14 (Q10). The result log includes information concerning whether the software of the ECU 18 has been successfully updated, the time when the activation has been completed, and the like. The transmission of the result log may be performed after the state of the SSSW 60 is switched from IG-OFF to IG-ON (or READY).

When the information acquisition unit 68 of the server device 14 acquires the result log (P7), the software update ends.

### [Software Update Process]

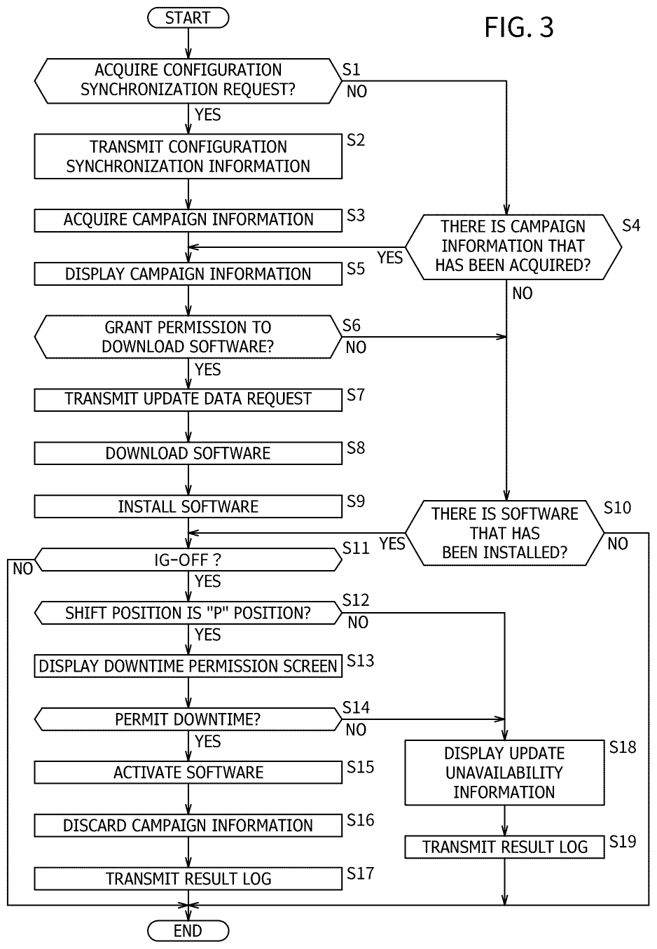

FIG. 3 is a flow chart showing the software update process performed by the software update device 24 according to one embodiment. This process is executed at a predetermined cycle when the state of the SSSW 60 is IG-ON (or READY).

In step S1, the software update device 24 determines whether or not the configuration synchronization request has been acquired from the server device 14. If it is determined that the configuration synchronization request has been acquired (step S1: YES), the process proceeds to step S2.

In step S2, the information transmission unit 30 of the software update device 24 transmits the configuration synchronization information to the server device 14. Then, the process proceeds to step S3.

In step S3, the information acquisition unit 32 of the software update device 24 acquires campaign information. Then, the process proceeds to step S5.

If it is determined in step S1 that no configuration synchronization request has been acquired (step S1: NO), the flow proceeds to step S4. In step S4, the software update device 24 determines whether or not there is campaign information that has been acquired in the campaign information storage unit 44. When it is determined that there is campaign information that has been acquired in the campaign information storage unit 44 (step S4: YES), the process proceeds to step S5.

In step S5, the display control unit 34 of the software update device 24 causes the display unit 58 of the IVI 50 to display the campaign information. Then, the process proceeds to step S6.

In step S6, the permission confirmation unit 36 of the software update device 24 determines whether the user has granted permission to download the software. If the software download is permitted, the process proceeds to step S7.

In step S7, the transmission request unit 38 of the software update device 24 transmits an update data request to the server device 14. Then, the process proceeds to step S8.

In step S8, the update processing unit 40 of the software update device 24 downloads the software. Then, the process proceeds to step S9.

In step S9, the update processing unit 40 of the software update device 24 installs the software. Then, the process proceeds to step S11.

If it is determined in step S4 that there is no acquired campaign information in the campaign information storage unit 44 (step S4: NO), or if the software download is rejected in step S6 (step S6: NO), the process proceeds to step S10. In step S10, the update processing unit 40 of the software update device 24 determines whether there is software that has been installed. If it is determined that the installed software is present (step S10: YES), the process proceeds to step S11. If it is determined that there is no installed software (step S10: NO), the software update process is terminated.

In step S11, the update processing unit 40 of the software update device 24 determines whether the state of the SSSW 60 is IG-OFF. If it is determined that the state of the SSSW 60 is IG-OFF (step S11: YES), the process proceeds to step S12. If it is determined that the state of the SSSW 60 is not IG-OFF (step S11: NO), the software update process is terminated.

In step S12, the update processing unit 40 of the software update device 24 determines whether the shift position is “P”. If it is determined that the shift position is “P” (step S12: YES), the process proceeds to step S13.

In step S13, the display control unit 34 of the software update device 24 causes the display unit 58 of the IVI 50 to display a downtime permission screen. Then, the process proceeds to step S14.

In step S14, the permission confirmation unit 36 of the software update device 24 determines whether or not the user has permitted downtime. If it is determined that the downtime has been permitted (step S14: YES), the process proceeds to step S15.

In step S15, the update processing unit 40 of the software update device 24 activates the software. Then, the process proceeds to step S16.

In step S16, the discarding processing unit 42 of the software update device 24 discards the campaign information stored in the campaign information storage unit 44.

In step S17, the update processing unit 40 of the software update device 24 creates a result log indicating that the software update was successful, and the information transmission unit 30 transmits the created result log to the server device 14. Then, the software update process is terminated.

If it is determined in step S12 that the shift position is not “P” (step S12: NO), or if it is determined in step S14 that the downtime is rejected (step S14: NO), the process proceeds to step S18. In step S18, the display control unit 34 of the software update device 24 causes the display unit 58 to display update infeasibility information indicating that software cannot be updated. Then, the process proceeds to step S19.

In step S19, the update processing unit 40 of the software update device 24 creates a result log indicating that the software update was unsuccessful, and the information transmission unit 30 transmits the created result log to the server device 14. Then, the software update process is terminated.

### [Campaign Application Process]

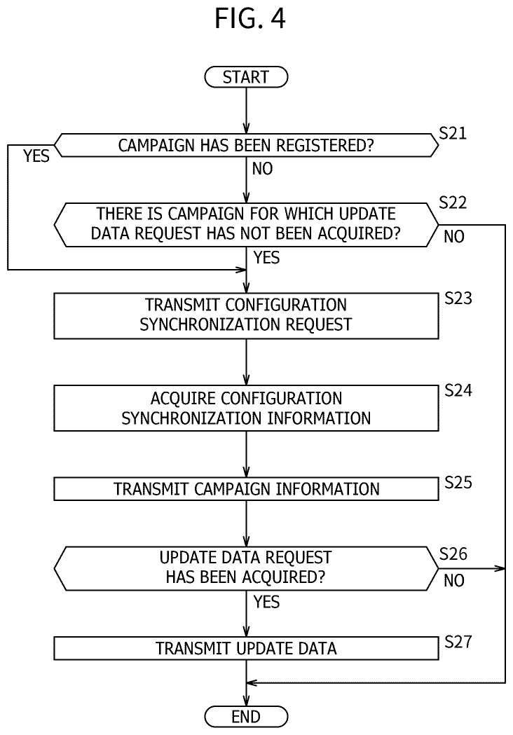

FIG. 4 is a flow chart showing a campaign application process performed by the server device 14 according to one embodiment. This process is executed at a predetermined period.

In step S21, the server device 14 determines whether a campaign has been registered. If it is determined that the campaign has been registered (step S21: YES), the process proceeds to step S23.

If it is determined that no campaign has been registered (step S21: NO), the process proceeds to step S22. In step S22, the server device 14 determines whether there is a campaign for which an update data request has not been acquired. If it is determined that there is a campaign for which the update data request has not been acquired (step S22: YES), the process proceeds to step S23. If it is determined that there is no campaign for which the update data request has not been acquired (step S22: NO), the campaign application process is terminated.

In step S23, the transmission processing unit 70 of the server device 14 transmits a configuration synchronization request to the vehicle 12. Then, the process proceeds to step S24.

In step S24, the information acquisition unit 68 of the server device 14 acquires the configuration synchronization information from the vehicle 12. Then, the process proceeds to step S25.

In step S25, the transmission processing unit 70 of the server device 14 transmits the campaign information to the vehicle 12. Then, the process proceeds to step S26.

In step S26, the server device 14 determines whether or not an update data request has been acquired. If it is determined that the update data request has been acquired (step S26: YES), the process proceeds to step S27. If it is determined that the update data request has not been acquired (step S26: NO), the campaign application process is terminated.

In step S27, the transmission processing unit 70 of the server device 14 transmits the update data to the vehicle 12. Then, the campaign application process is terminated.

### [Campaign Information Management Process]

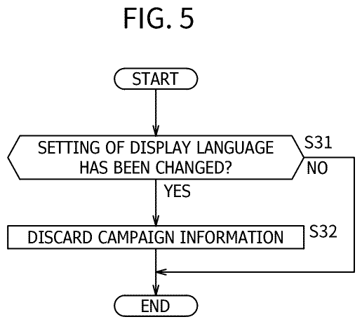

FIG. 5 is a flow chart showing a campaign information management process performed by the software update device 24 according to one embodiment. This process is executed at a predetermined period.

In step S31, the discarding processing unit 42 of the software update device 24 determines whether the setting of the display language of the display unit 58 of the IVI 50 has been changed. If the setting of the display language of the display unit 58 has been changed (step S31: YES), the process proceeds to step S32. If the setting of the display language of the display unit 58 has not been changed (step S31: NO), the campaign information management process is terminated.

In step S32, the discarding processing unit 42 of the software update device 24 discards the campaign information stored in the campaign information storage unit 44 of the software update device 24. Then, the campaign information management process is terminated.

### [Operation of Software Update Device]

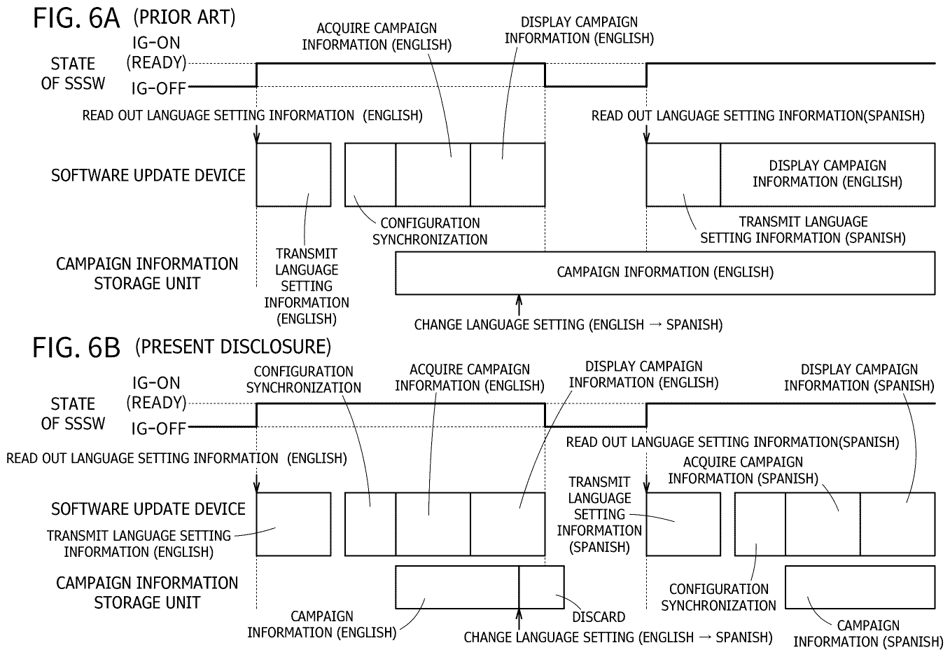

FIGS. 6A and 6B are diagrams for explaining the operation of the software update device 24. FIG. 6A illustrates the operation of a conventional software update device 24. FIG. 6B illustrates the operation of the software update device 24 of the present disclosure.

In the conventional software update device 24 and the software update device 24 of the present disclosure, the information transmission unit 30 reads out the current language setting information from the language setting unit 56 of the IVI 50 every time the state of the SSSW 60 is switched from IG-OFF to IG-ON (or READY). The information transmission unit 30 transmits the read-out language setting information to the server device 14. The transmission processing unit 70 of the server device 14 transmits to the software update device 24 the campaign information for the language corresponding to the language setting information. The information acquisition unit 32 of the software update device 24 acquires the campaign information and stores the campaign information in the campaign information storage unit 44. The display control unit 34 of the software update device 24 causes the display unit 58 of the IVI 50 to display the campaign information stored in the campaign information storage unit 44.

For example, when the language setting of the display unit 58 of the IVI 50 is English, the campaign information storage unit 44 stores campaign information in English. Therefore, the display control unit 34 of the software update device 24 causes the display unit 58 of the IVI 50 to display the campaign information in English.

In the conventional software update device 24, even when the language setting is changed, the campaign information in the campaign information storage unit 44 is not discarded. Therefore, in the conventional software update device 24, there is a problem that the campaign information in English is displayed on the display unit 58 even when the language setting of the display unit 58 of the IVI 50 is changed from English to Spanish, for example.

Therefore, in the case of the software update device 24 of the present disclosure, the campaign information stored in the campaign information storage unit 44 is discarded by the discarding processing unit 42 when the language setting is changed. For example, when the language setting of the display unit 58 of the IVI 50 is changed from English to Spanish, the discarding processing unit 42 discards the campaign information stored in the campaign information storage unit 44. After the campaign information is discarded, the display control unit 34 cannot cause the display unit 58 to display the campaign information until the software update device 24 acquires new campaign information. After the server device 14 acquires the language setting information indicating that the setting language of the display unit 58 is Spanish, the server device 14 transmits the campaign information in Spanish to the software update device 24. Therefore, the information acquisition unit 32 of the software update device 24 acquires the campaign information in Spanish, and the campaign information in Spanish is stored in the campaign information storage unit 44. Thus, in the software update device 24 of the present disclosure, the campaign information in Spanish, which is the display language after the setting is changed, is displayed on the display unit 58 of the IVI 50.

### Other Embodiments

The software update system 10 of the above embodiment may be modified as explained below.

When the campaign information is discarded, the transmission request unit 38 of the software update device 24 may transmit to the server device 14 a signal requesting the transmission of the campaign information.

If the display language set in the language setting unit 56 of the IVI 50 is different from the display language of the campaign information stored in the campaign information storage unit 44 of the software update device 24, the discarding processing unit 42 of the software update device 24 may discard the campaign information stored in the campaign information storage unit 44.

When the display language set in the language setting unit 56 of the IVI 50 is changed, the information transmission unit 30 of the software update device 24 may transmit to the server device 14 language setting information indicating the changed display language.

With respect to the above embodiments, the following supplementary notes are further disclosed.

### (Supplementary Note 1)

A software update system (10) includes a vehicle (12) and a server device (14) configured to communicate with the vehicle via a network (16), and also includes a language setting unit (56) configured to set a display language of information to be displayed on a display unit (58), based on operation input performed by a user, a campaign information acquisition unit (32) configured to acquire campaign information, which is information concerning a software update process for an electronic control unit (18) provided in the vehicle, from the server device via the network, a display control unit (34) configured to cause the display unit to display the campaign information acquired by the campaign information acquisition unit, and a discarding processing unit (42) configured to discard, in a case where the display language is changed by the language setting unit, the campaign information acquired before the display language is changed. According to such a configuration, it is possible to suppress the campaign information of the display language before the setting is changed from being displayed on the display unit.

### (Supplementary Note 2)

In the software update system described in Supplementary note 1, the server device may include a language setting information acquisition unit (68) configured to acquire information indicating the display language set by the language setting unit, and a transmission processing unit (70) configured to transmit to the vehicle the campaign information corresponding to the display language indicated by the information acquired by the language setting information acquisition unit. According to such a configuration, the campaign information of the display language after the setting is changed can be displayed on the display unit.

### (Supplementary Note 3)

In the software update system described in Supplementary note 1, the campaign information acquisition unit may cause a campaign information storage unit (44) to store the campaign information acquired from the server device, the display control unit may cause the display unit to display the campaign information stored in the campaign information storage unit, and in a case where the campaign information stored in the campaign information storage unit is discarded by the discarding processing unit, the campaign information acquisition unit may store the campaign information newly acquired from the server device in the campaign information storage unit, and the display control unit may cause the display unit to display the campaign information newly stored in the campaign information storage unit. According to such a configuration, the campaign information of the display language after the setting is changed can be displayed on the display unit.

### (Supplementary Note 4)

The software update system according to Supplementary note 2 may further comprise a transmission request unit (38) configured to request the server device to transmit the campaign information in a case where the campaign information is discarded by the discarding processing unit. According to such a configuration, the campaign information of the display language after the setting is changed can be displayed on the display unit.

### (Supplementary Note 5)

The software update system according to Supplementary note 2 may further include: a permission confirmation unit (36) configured to perform a confirmation process to confirm with the user whether to permit the software update process for the electronic control unit; and an information transmission unit (30) configured to transmit to the server device information indicating the result of the confirmation process by the permission confirmation unit, wherein the transmission processing unit may repeatedly transmit to the vehicle the campaign information corresponding to the display language indicated by the information acquired by the language setting information acquisition unit until the information indicating the result of the confirmation process is received. According to such a configuration, the campaign information of the display language after the setting is changed can be displayed on the display unit.

### (Supplementary Note 6)

A software update system includes a vehicle and a server device configured to communicate with the vehicle via a network, wherein the software update system includes a language setting unit configured to set a display language of information to be displayed on a display unit, based on an operation input performed by a user, a campaign information acquisition unit configured to acquire campaign information, which is information concerning a software update process for an electronic control unit provided in the vehicle, from the server device via the network, and a display control unit configured to cause the display unit to display the campaign information acquired by the campaign information acquisition unit, wherein the campaign information acquisition unit acquires language setting information indicating the display language set by the language setting unit and acquires, from the server device via the network, the campaign information corresponding to the display language indicated by the language setting information. According to such a configuration, the campaign information of the display language after the setting is changed can be displayed on the display unit.

### (Supplementary Note 7)

The software update system according to Supplementary note 6 may further include a discarding processing unit configured to discard the campaign information stored in the storage unit in a case where the display language indicated by the language setting information is different from the display language of the campaign information stored in the storage unit. According to such a configuration, the campaign information of the display language after the setting is changed can be displayed on the display unit.

### (Supplementary Note 8)

The software update system described in Supplementary note 1 or 6 further includes a language setting information transmission unit configured to transmit language setting information indicating the display language set by the language setting unit to the server device when a starting switch (60) of the vehicle is switched from off to on or when the display language is changed by the language setting unit. According to such a configuration, it is possible to suppress the campaign information of the display language before the setting is changed from being displayed on the display unit.

### (Supplementary Note 9)

A software update system includes a vehicle and a server device configured to communicate with the vehicle via a network and also includes: a language setting unit configured to set, based on an operation input performed by a user, a display language of information to be displayed on a display unit; a language setting information transmission unit (30) configured to transmit to the server device language setting information indicating the display language set by the language setting unit, in a case where a starting switch of the vehicle is switched from OFF to ON or in a case where the display language is changed by the language setting unit; a campaign information acquisition unit configured to acquire, from the server device via the network, campaign information which is information concerning a software update process for an electronic control unit provided in the vehicle; and a display control unit configured to cause the display unit to display the campaign information acquired by the campaign information acquisition unit. According to such a configuration, the campaign information of the display language after the setting is changed can be displayed on the display unit.

### (Supplementary Note 10)

A software update device (24) in the software update system according to any one of Supplementary notes 1 to 5 includes the language setting unit, the campaign information acquisition unit, the display control unit, and the discarding processing unit. According to such a configuration, it is possible to suppress the campaign information of the display language before the setting is changed from being displayed on the display unit.

### (Supplementary Note 11)

A software update device in the software update system described in Supplementary note 6 or 7 includes the language setting unit, the campaign information acquisition unit, and the display control unit. According to such a configuration, the campaign information of the display language after the setting is changed can be displayed on the display unit.

### (Supplementary Note 12)

A software update device in the software update system described in Supplementary note 9 includes the language setting unit, the language setting information transmission unit, the campaign information acquisition unit, and the display control unit. According to such a configuration, the campaign information of the display language after the setting is changed can be displayed on the display unit.

### (Supplementary Note 13)

A software update method for performing software update processing on an electronic control unit provided in a vehicle includes: a language setting step of setting, based on an operation input performed by a user, a display language of information to be displayed on a display unit; a campaign information acquisition step of acquiring campaign information, which is information concerning the software update process, from a server device via a network; a display control step of causing the display unit to display the campaign information acquired in the campaign information acquisition step; and a discarding processing step of discarding the campaign information acquired before the display language is changed, in a case where the display language is changed in the language setting step. This can suppress the campaign information of the display language before the setting is changed from being displayed on the display unit.

### (Supplementary Note 14)

A software update method for performing software update processing on an electronic control unit provided in a vehicle includes: a language setting step of setting, based on an operation input performed by a user, a display language of information to be displayed on a display unit; a campaign information acquisition step of acquiring campaign information, which is information concerning the software update process, from a server device via a network; and a display control step of causing the display unit to display the campaign information acquired in the campaign information acquisition step, wherein the campaign information acquisition step acquires language setting information indicating the display language set in the language setting step and acquires the campaign information corresponding to the display language indicated by the language setting information from the server device via the network. This allows the campaign information of the display language after the setting is changed to be displayed on the display unit.

### (Supplementary Note 15)

A software update method for performing software update processing on an electronic control unit provided in a vehicle includes: a language setting step of setting, based on an operation input performed by a user, a display language of information to be displayed on a display unit; a language setting information transmission step of transmitting, in a case where a starting switch of the vehicle is switched from off to on or in a case where the display language is changed in the language setting step, language setting information indicating the display language set by the language setting step to a server device via a network; a campaign information acquisition step of acquiring campaign information, which is information related to the software update processing, from the server device via the network; and a display control step of causing the display unit to display the campaign information acquired in the campaign information acquisition step. This allows the campaign information of the display language after the setting is changed to be displayed on the display unit.

### (Supplementary Note 16)

A program of the present disclosure causes a computer to execute the software update method described in any one of Supplementary notes 13 to 15. This can suppress the campaign information of the display language before the setting is changed from being displayed on the display unit.

Although the present disclosure has been detailed, the present disclosure is not limited to the individual embodiments described above. These embodiments may be variously added, replaced, altered, partially deleted, etc., without departing from the scope of the present disclosure or the intent of the present disclosure as derived from the claims and their equivalents. These embodiments can also be implemented in combination. For example, in the above-described embodiment, the order of the operations and the order of the processes are shown as an example and are not limited to these. The same applies to the case where numerical values or mathematical expressions are used in the description of the above-described embodiment.

1. A software update system comprising a vehicle and a server device configured to communicate with the vehicle via a network, the software update system comprising
one or more processors that execute computer-executable instructions stored in a memory,
wherein the one or more processors execute the computer-executable instructions to cause the software update system to:
set a display language of information to be displayed on a display unit, based on an operation input performed by a user;
acquire campaign information, which is information concerning a software update process for an electronic control unit provided in the vehicle, from the server device via the network;
cause the display unit to display the acquired campaign information; and
discard, in a case where the display language is changed, the campaign information acquired before the display language is changed.

2. The software update system according to claim 1, wherein
the server device includes one or more processors that execute computer-executable instructions stored in a memory,
the one or more processors execute the computer-executable instructions to cause the server device to:
acquire information indicating the set display language; and
transmit to the vehicle the campaign information corresponding to the display language indicated by the acquired information.

3. The software update system according to claim 1, wherein the one or more processors execute the computer-executable instructions to cause the software update system to:
store the campaign information acquired from the server device in a campaign information storage unit;
display the campaign information stored in the campaign information storage unit on the display unit; and
in a case where the campaign information stored in the campaign information storage unit is discarded, store the campaign information newly acquired from the server device in the campaign information storage unit and cause the display unit to display the campaign information newly stored in the campaign information storage unit.

4. The software update system according to claim 2, wherein the one or more processors execute the computer-executable instructions to cause the software update system to
request the server device to transmit the campaign information in a case where the campaign information is discarded.

5. The software update system according to claim 2, wherein the one or more processors execute the computer-executable instructions to cause the software update system to
perform a confirmation process to confirm with the user whether to permit the software update process for the electronic control unit;
transmit information indicating a result of the confirmation process to the server device; and
transmit the campaign information corresponding to the display language indicated by the acquired information to the vehicle repeatedly until the information indicating the result of the confirmation process is received.

6. A software update system comprising a vehicle and a server device configured to communicate with the vehicle via a network, the software update system comprising
one or more processors that execute computer-executable instructions stored in a memory,
wherein the one or more processors execute the computer-executable instructions to cause the software update system to:
set a display language of information to be displayed on a display unit, based on an operation input performed by a user;
acquire campaign information, which is information concerning a software update process for an electronic control unit provided in the vehicle, from the server device via the network;
cause the display unit to display the acquired campaign information; and
acquire language setting information indicating the set display language and acquire, from the server device via the network, the campaign information corresponding to the display language indicated by the language setting information.

7. The software update system according to claim 6, wherein the one or more processors execute the computer-executable instructions to cause the software update system to
discard the campaign information stored in a storage unit in a case where the display language indicated by the language setting information is different from the display language of the campaign information stored in the storage unit.

8. The software update system according to claim 1, wherein the one or more processors execute the computer-executable instructions to cause the software update system to
transmit language setting information indicating the set display language to the server device in a case where a starting switch of the vehicle is switched from off to on or in a case where the display language is changed.

9. A software update system comprising a vehicle and a server device configured to communicate with the vehicle via a network, the software update system comprising
one or more processors that execute computer-executable instructions stored in a memory,
wherein the one or more processors execute the computer-executable instructions to cause the software update system to:
set a display language of information to be displayed on a display unit, based on an operation input performed by a user;
transmit language setting information indicating the set display language to the server device in a case where a starting switch of the vehicle is switched from off to on or in a case where the display language is changed;
acquire campaign information, which is information concerning a software update process for an electronic control unit provided in the vehicle, from the server device via the network; and
cause the display unit to display the acquired campaign information.

10. A software update device in the software update system according to claim 1, the software update device comprising
one or more processors that execute computer-executable instructions stored in a memory,
wherein the one or more processors execute the computer-executable instructions to cause the software update device to:
set a display language of information to be displayed on a display unit, based on an operation input performed by a user;
acquire campaign information, which is information concerning a software update process for an electronic control unit provided in the vehicle, from the server device via the network;
cause the display unit to display the acquired campaign information; and
discard, in a case where the display language is changed, the campaign information acquired before the display language is changed.

11. A software update device in the software update system according to claim 6, the software update device comprising
one or more processors that execute computer-executable instructions stored in a memory,
wherein the one or more processors execute the computer-executable instructions to cause the software update device to:
set a display language of information to be displayed on a display unit, based on an operation input performed by a user;
acquire campaign information, which is information concerning a software update process for an electronic control unit provided in the vehicle, from the server device via the network;
cause the display unit to display the acquired campaign information; and
acquire language setting information indicating the set display language and acquire, from the server device via the network, the campaign information corresponding to the display language indicated by the language setting information.

12. A software update device in the software update system according to claim 9, the software update device comprising
one or more processors that execute computer-executable instructions stored in a memory,
wherein the one or more processors execute the computer-executable instructions to cause the software update device to:
set a display language of information to be displayed on a display unit, based on an operation input performed by a user;
transmit language setting information indicating the set display language to the server device in a case where a starting switch of the vehicle is switched from off to on or in a case where the display language is changed;
acquire campaign information, which is information concerning a software update process for an electronic control unit provided in the vehicle, from the server device via the network; and
cause the display unit to display the acquired campaign information.

13. A software update method for performing a software update process for an electronic control unit provided in a vehicle, the method comprising:
setting a display language of information to be displayed on a display unit, based on an operation input performed by a user;
acquiring campaign information, which is information concerning the software update process, from a server device via a network;
causing the display unit to display the acquired campaign information; and
discarding, in a case where the display language is changed, the campaign information acquired before the display language is changed.

14. A software update method for performing a software update process for an electronic control unit provided in a vehicle, the method comprising:
setting a display language of information to be displayed on a display unit, based on an operation input performed by a user;
acquiring campaign information, which is information concerning the software update process, from a server device via a network;
causing the display unit to display the acquired campaign information; and
acquiring language setting information indicating the set display language and acquiring, from the server device via the network, the campaign information corresponding to the display language indicated by the language setting information.

15. A software update method for performing a software update process for an electronic control unit provided in a vehicle, the method comprising:
setting a display language of information to be displayed on a display unit, based on an operation input performed by a user;
transmitting language setting information indicating the set display language to a server device via a network in a case where a starting switch of the vehicle is switched from off to on or in a case where the display language is changed;
acquiring campaign information, which is information concerning the software update process, from the server device via the network; and
causing the display unit to display the campaign information acquired in the acquiring of the campaign information.

16. A computer-readable non-transitory storage medium storing a program, wherein the program causes a computer to execute the software updating method according to claim 13.

17. A computer-readable non-transitory storage medium storing a program, wherein the program causes a computer to execute the software updating method according to claim 14.

18. A computer-readable non-transitory storage medium storing a program, wherein the program causes a computer to execute the software updating method according to claim 15.
